(19) United States
(12) Patent Application Publication
(10) Pub. No.: US 2003/0105801 A1
(43) Pub. Date: Jun. 5, 2003

(54) Method, system and agent for connecting event consumers to event producers in a distributed event management system

(75) Inventors: Edwin Tse, Montreal (CA); David McAleer, Beaconsfield (CA); Andre Godin, Laval (CA); Nicolas Gosselin, Blainville (CA)

Correspondence Address: SANDRA BEAUCHESNE, Ericsson Canada Inc., Patent Department (LMC/UP), 8400 Decarie Blvd., Town Mount Royal, QC, H4P 2N2, CA

(73) Assignee: Telefonaktiebolaget L M Ericsson (publ) (signed)

(21) Appl. No.: 09/999,084

(22) Filed: Nov. 30, 2001

(51) Int. Cl. G06F 15/16

(52) U.S. Cl. 709/202; 709/224

(57) ABSTRACT

In a management system, a method, system, and agent for dynamically connecting event producers to event consumers, when the type of event notifications requested by event consumer(s) matches the type of event notification issued event producer(s). The agent receives advertisement or subscription request from event producers and consumers, and detects a match between the type of event notifications created by event producers and requested by event consumers. When a match is detected, the agent dynamically connects the egress port of the event producer to the ingress port of the event consumer. When another subscription request is received by the agent from another event consumer for the same type of event notifications, the agent first detects the optimal duplication node for duplicating the event notifications before sending them to both event consumers. The agent comprises a processor, an event producer table, and an event consumer table for storing the event notifications type each node generates or requests.

### BACKGROUND OF THE INVENTION

1. Field of the Invention

The present invention relates to network management, and in particular to a method, system and agent for dynamically connecting event consumers to event producers in a distributed event management system.

2. Description of the Related Art

Event Channel Networks (ECN), also called herein event management systems, or simply management systems, are network of nodes whose function is to acquire event notifications from event producers, process, and relay the event notifications to event consumers. Event Producers (EPs) are nodes, components, or functionalities of the managed system (or network) that are managed, or supervised by a management system. Event Consumers (ECs) are those nodes of the ECN that “consume” event notifications, i.e. for example, event consumers acquire event notifications from other nodes, such as for example from EPs, and process or further relay the event notifications. Multiple levels of event consumers may also exist, so that for example a first event consumer may acquire event notifications from event producers, and in turn further relay some event notifications to yet another event consumer. In most cases, the ECN is a distributed system so that its nodes can be deployed on multiple hosts that are physically distributed into a wide geographical area. An example of ECN implementation is a distributed fault management system that monitors abnormal conditions of telecommunication networks, fleet management networks, building security systems, and computing systems. In such a configuration, event notifications are generated by event producers (the managed nodes), may carry alarm information and are relayed through the store-and-forward capabilities of the ECN nodes until they reach the appropriate event consumer(s).

Reference is now made to FIG. 1 (Prior Art), wherein there is shown a high-level network diagram representative of an ECN (the management system) 10 responsible for supervising a managed network 12. The managed network 12 may comprise one or more types of event producers 14ᵢ, such as for example the PC 14₁, the server 14₂, the door access device 14₃, etc. When abnormal conditions occur (such as for example a malfunction of the PC 14₁, or an open condition of device 14₃), event producers 14ᵢ may issue alarm notifications 16, which are collected by the ECN 10 and relayed to one or more event consumers, such as for example the network management terminal 18, wherein the alarm information from alarms 16 can be displayed, thus allowing, for example, a network administrator to take corrective action for the original abnormal condition that generated the alarms. It is to be noted that the network management terminal 18 is generally understood to be part of the ECN 10, although in FIG. 1 it is illustrated outside the ECN 10 for clarity purposes.

In FIG. 2 (Prior Art), there is shown a generic illustration of a monitored network 12, comprising a plurality of event producers 14ᵢ, connected to the ECN 10, and relaying to the ECN event notifications 16. In the typical scenario, the event notifications are generated within event producers 14ᵢ that are normally of the same type (telecommunications nodes, PCs, fleet vehicles, etc) and relayed to the event consumers 22ᵢ of the ECN 10.

Reference is now made to FIG. 3 (Prior Art) wherein there is shown one exemplary configuration for connecting an event producer (EP1) 20 to an ECN's one or more event consumers (EC1, EC2, EC3) 22ᵢ. The ECN may also comprise a plurality of intermediate nodes (N1, N2, N3) 24ᵢ through which the event notifications 16 are passed before reaching the event consumers 22ᵢ. For example, event producer EP1 20 may generate event notifications of a certain type in which the consumers 22₁-22₃ are interested, and for which they have subscribed their interest to ECN. Therefore, that type of event notifications 16 are sent by the event producer EP1 20 to the node N1 24₁, and further forwarded to the intermediate nodes N2 and N3, 24₂ and 24₃, which again push the event notifications to event consumers EC1 and EC2, 22₁ and 22₂. Node 24₁ also forwards the alarm 16 directly to event consumer EC3 22₃.

It is to be noted that in every configuration shown in FIGS. 1, 2, and 3, the communication links connecting the event producers to the event consumers, including the intermediate communication links 25 shown in FIG. 3 between the event producers and the intermediate nodes of the ECN on one side, and the nodes of the ECN and the event consumers on the second side, are static links, i.e. their configuration is established during the set-up the ECN network and cannot be dynamically changed during operation. For example, with reference being made specifically to FIG. 3, the event producer EP1 20 can only send event notifications to the event consumer EC1 22₁ via nodes N1 24₁ and N2 24₂, although in certain circumstances it would be preferable to send the event notifications 16 directly to the event consumer EC1 22₁, without any intermediate step. Furthermore, the store and forward nature of the ECN nodes often introduces event propagation delays in the transmission of the event notifications from event producers to event consumers. It also reduces the event throughput in the cases wherein the ECN guarantees event integrity (e.g. no event notification loss).

Although there is no prior art solution as the one proposed hereinafter for solving the above-mentioned deficiencies, the U.S. Pat. No. 5,925,108 issued to Johnson et al (hereinafter called Johnson) bears some relation with the present invention. Johnson teaches a system and method that separate the order in which event handlers register, from the order in which the event handlers are notified of events. In Johnson, the notification order is determined by event producers, and therefore may be reversed without re-registering the event handlers. The events may be broadcast, may carry data between event handlers, and may be consumed to prevent further notifications. However, in Johnson the communication links established between even producers and event consumers are static, i.e. they do not change during operation of the management network.

U.S. Pat. No. 5,566,337 issued to Szymanski et al (hereinafter called Szymanski) teaches a method and apparatus for distributing events in an operating system. According to Szymanski, an event producer generates events and detects that an event has occurred in the computer, and that an event consumer needs to be informed. The system for distributing events includes a store for storing a specific set of events of which the given event is part, and an event manager control unit for receiving the events from the event producer. The system compares the received event to the stored set of events, and distributes an appropriate event to an appropriate event consumer. However, in Szymanski the issue of the connection between event producers and event consumers is not specifically addressed since both event consumers and even producers are part of the same computer system.

All the above-described management systems utilize static communications links between event producers and event consumers for the transmission of event notifications. This consists in a major drawback of the existing systems, since a given path may be preferable in some transmission scenarios, while being inconvenient in others. Moreover, in cases wherein a plurality of intermediate nodes are used for relaying a given type of event notifications, major delays may be engendered in the transmission of the event notifications, thus causing delays in the repair of the their cause. This unduly prolongs an abnormal condition in the managed network.

Accordingly, it should be readily appreciated that in order to overcome the deficiencies and shortcomings of the existing solutions, it would be advantageous to have a method and system for dynamically connecting an event consumer with an event producer. Furthermore, it would be also advantageous to have a method and system that avoid propagation delays while maintaining data integrity.

The present invention provides such as solution.

### SUMMARY OF THE INVENTION

In one aspect, the present invention is a method for dynamically connecting an event consumer to at least an event producer, the method comprising the steps of:

i) transmitting a first Subscription Request message from a first event consumer to an agent, the first Subscription Request message comprising an indication of a type of event notifications the first event consumer requests for receiving;

ii) upon receipt of the first Subscription Request message, detecting in the agent if an event producer generates event notifications of the type requested by the first event consumer;

iii) if an event producer generates event notifications of the type indicated by the event consumer, dynamically connecting the event producer to the first event consumer; and

iv) sending event notifications of the type indicated by the event consumer from the event producer to the first event consumer.

In another aspect, the present invention is a management system comprising:

a first event consumer transmitting a first Subscription Request message, the first Subscription Request message comprising an indication of a type of event notifications the first event consumer requests for receiving;

one or more event producers;

an agent receiving the first Subscription request from the first event consumer and, upon receipt of the first Subscription Request message, detecting if an event producer of the one or more event producers generates event notifications of the type requested by the first event consumer;

wherein if an event producer generates event notifications of the type indicated by the event consumer, the agent dynamically connects the event producer to the first event consumer so that the event notifications of the type indicated by the event consumer are sent from the event producer to the first event consumer.

In yet another aspect, the present invention is an agent of a management system, comprising:

an event producer table comprising information related to event producers managed by the agent, the information related to event producers managed by the agent comprising a type of event notifications generated by the event producers;

an event consumer table comprising information related to event consumers managed by the agent, the information related to event consumers managed by the agent comprising a type of event notifications requested by the event consumers; and

a processor for detecting a match between the type of event notifications generated by a first event producer from the event consumers managed by the agent, and the type of event notifications requested by a first event consumer from the event consumers managed by the agent;

wherein when the match is detected, the processor dynamically connects the first event producer to the first event consumer;

whereby the event notifications of the matched type are transmitted from the first event producer to the first event consumer.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a high-level network diagram of representative of an Event Channel Network (ECN) responsible for supervising a managed network;

FIG. 2 (Prior Art) is a generic illustration of a monitored network connected to an ECN;

FIG. 3 (Prior Art) is an exemplary configuration for connecting an event producer to one or more event consumers;

FIG. 4.a is the first part of an exemplary nodal operation and signal flow diagram of the preferred embodiment of the invention;

FIG. 4.b is the second part of the exemplary nodal operation and signal flow diagram of the preferred embodiment of the invention;

FIG. 4.c is the third part of the exemplary nodal operation and signal flow diagram of the preferred embodiment of the invention;

FIG. 5 is an exemplary high-level block diagram of an agent according to the preferred embodiment of the invention;

FIG. 6 is an exemplary list of parameters that may be used by an event consumer for subscribing with the ECN for a certain type of event notifications, according to the preferred embodiment of the invention;

FIG. 7.a is an exemplary relational table of preferred connection paths between an event producer and multiple event consumers, according to a first variant of the preferred embodiment of the present invention; and

FIG. 7.b is another exemplary illustration of yet another method for detecting an optimal connection path according to a second variant of the preferred embodiment of the present invention.

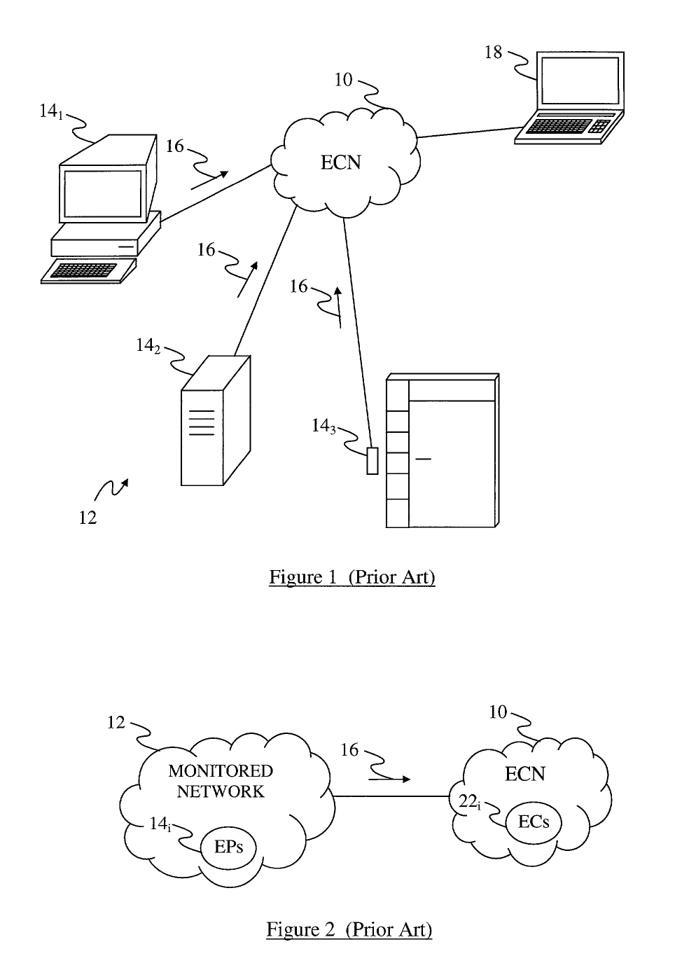

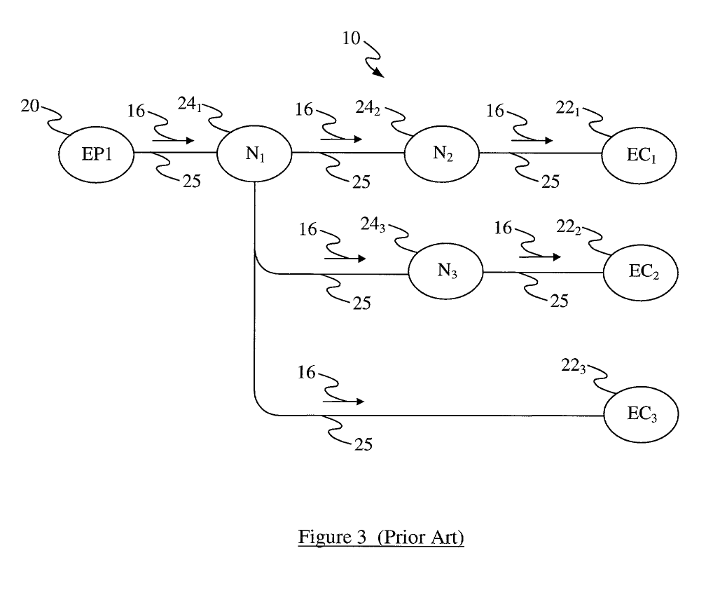

### DETAILED DESCRIPTION OF THE PREFERRED EMBODIMENTS

The innovative teachings of the present invention will be described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

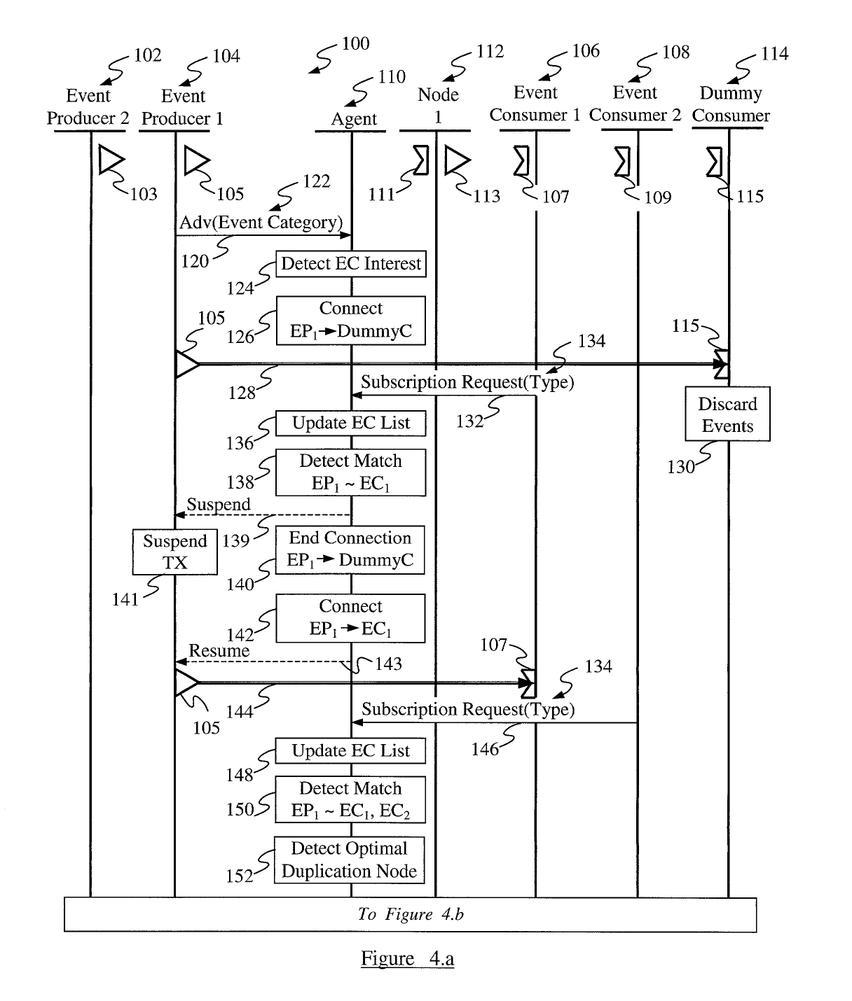

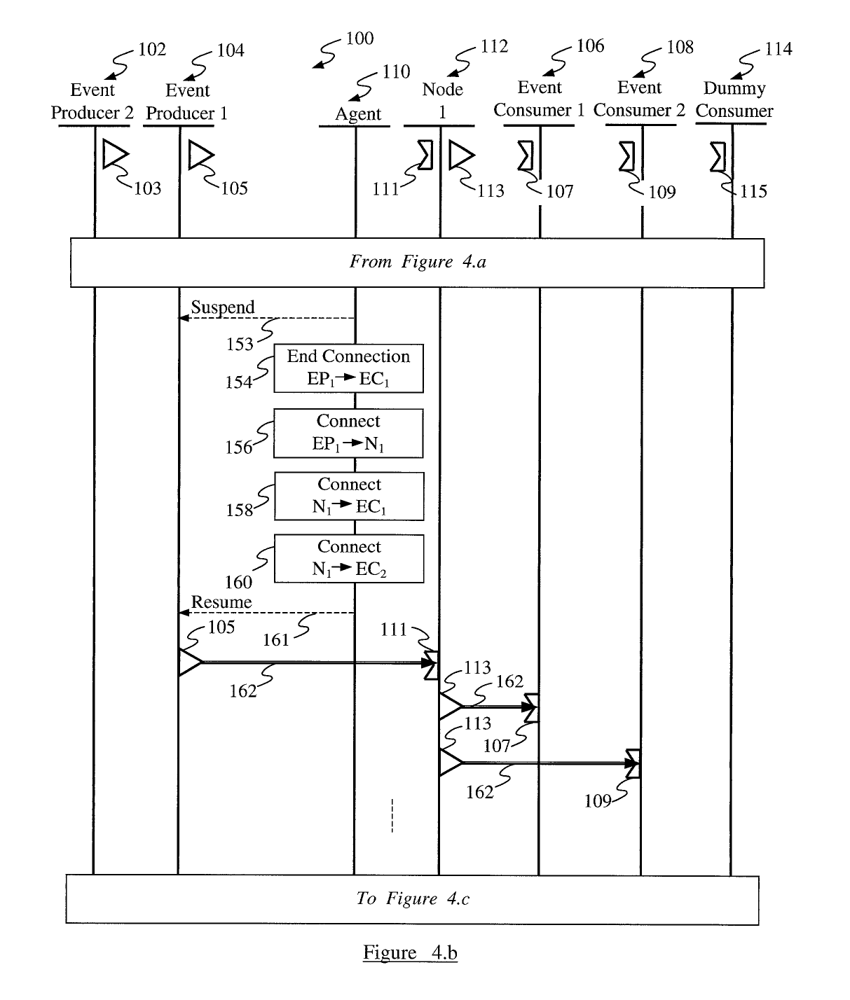

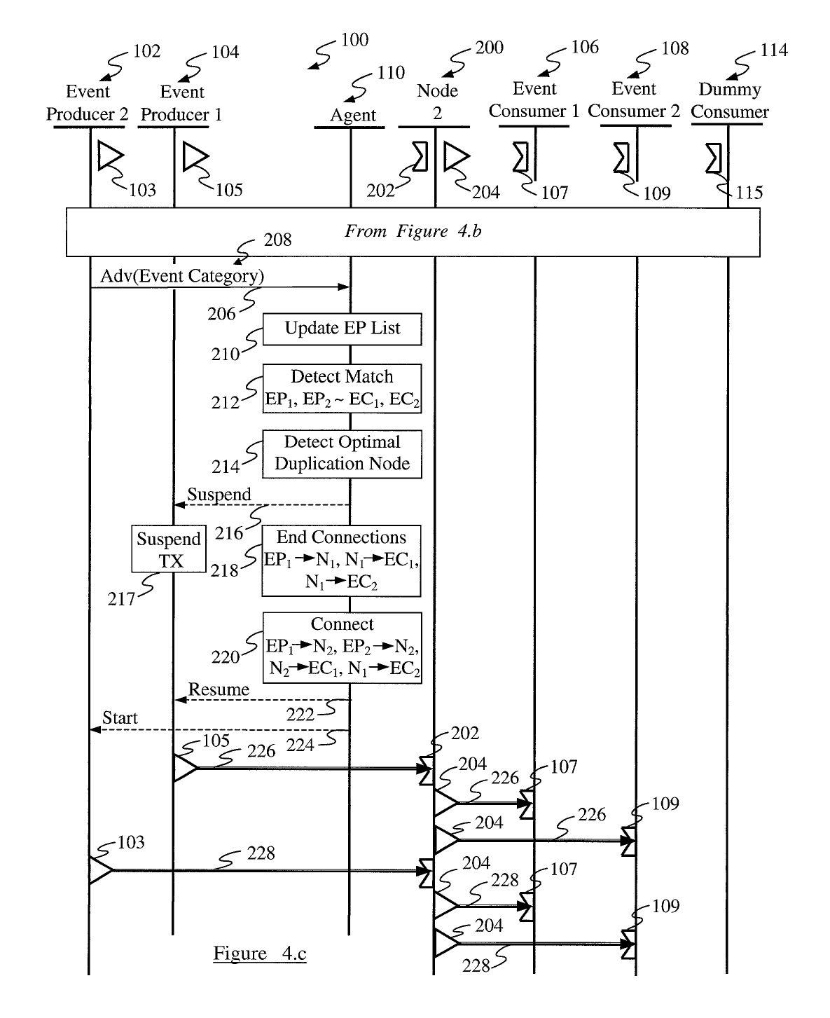

Referring now to FIG. 4.a, depicted therein is a first part of a nodal operation and signal flow diagram illustrating the preferred embodiment of the present invention related to the dynamic configuration of a transmission path between an event producer and one or more event consumers. In FIG. 4, there is shown a management system 100 comprising one or more event producers, such as for example event producers 102 and 104, each having a respective egress port 103 and 105 for sending event notifications. The management system 100 further comprises at least one event consumer such as for example event consumers 106 and 108, each having an ingress port 107 and 109, respectively, for receiving event notifications. The management system 100 further comprises at least one agent 110, which is responsible for managing the connections and communications between the event producers 102-104 and the event consumers 106-108. The management system 100 may further comprise one or more intermediate nodes, such as for example node 112 responsible in some cases for relaying event notifications from the event producers toward the event consumers, and a dummy event consumer 114 that discards every event notification received on its ingress port 115. The dummy event consumer 114 is used when none of the event consumers is interested in receiving certain event notifications, and acts to discards those event notifications.

With reference to FIG. 4, first, an event producer, such as for example event producer 104, transmits an event notification advertisement message 120 to the agent 110 and for specifying which categories 122 of event notifications, the event producer 104 can generate. Upon receipt of the message 120, because of its knowledge of all nodes connected to the management system 100, the agent 110 detects in action 124 that no event consumer of the management system 100 is so far interested in receiving this type of event notifications, and therefore connects the egress port 105 of the event producer 104 to the ingress port 115 of the dummy event consumer 114, action 126. As a consequence, all the event notifications of the event notification category 122 generated by the event producer 104 are received, action 128, and discarded, action 130, by the dummy consumer 114.

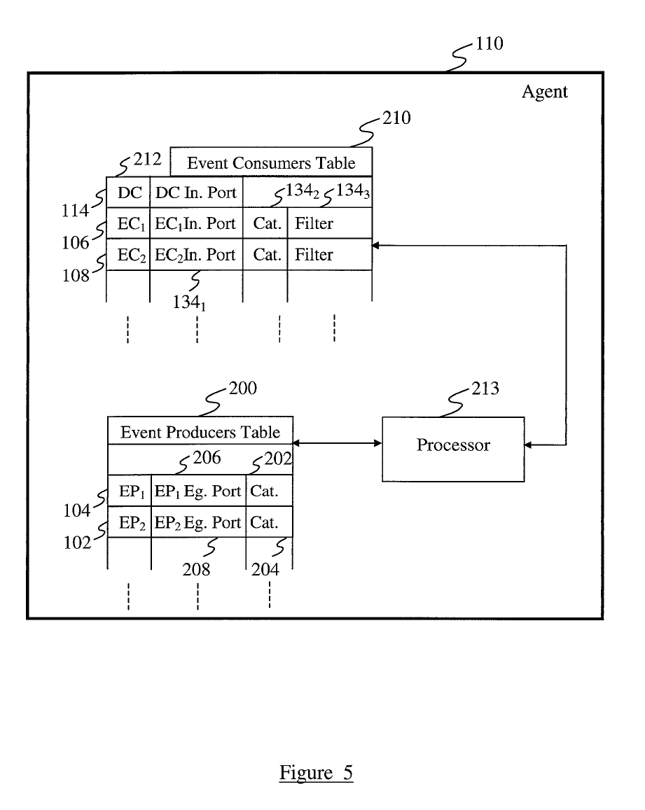

Reference is now made to FIG. 5, which illustrates a high-level block diagram of the agent 110 according to the preferred embodiment of the invention. Shown in FIG. 5 is the agent 110, which comprises an event producer table (or list) 200 having the event notification categories 202 and 204 that each one of the event producer generates, as well as the respective egress port identity 206 and 208 that each such event producer use for sending event notifications. At this point in time, following the receipt of the advertisement message 120 in FIG. 4.a, the event producers table 200 only comprises one line directed to the event producer EP1 104.

The agent 110 also comprises an event consumer list 210 having each event consumer managed by the agent 110. At this point in time, wherein no event consumer is registered with the agent 110, the list 210 only comprises one line directed to the dummy event consumer (DC) 114, with the identity of the ingress port 212 that the dummy event consumer uses for receiving event notifications. Therefore, based on the information contained in the event producer table 200 and the event consumers table 210, a processor 213 of the agent 110 is capable of detecting in action 124 of FIG. 4.a that besides the dummy event customer 114, there is no other event consumer interested in receiving the event notifications from the event producer 104 and, as a consequence, establishes a connection between the event producer 104 egress port 105 and the dummy event consumer 114 ingress port 115.

With reference being now made back to FIG. 4, at a later point in time, an event consumer of the management system 100, such as for example event consumer 106 may manifest an interest in receiving a certain type of event notifications. For that purpose, the event consumer 106 sends a subscription request message 132 to the agent 110, subscription request message 132 comprising at least one type parameter 134 indicative of which event notifications the event customer 106 is interested in receiving.

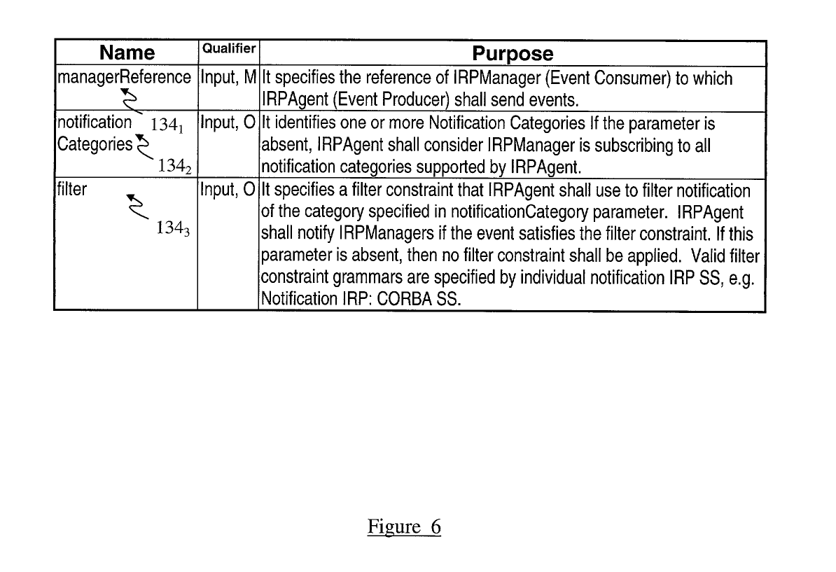

Reference is now made jointly to FIG. 4.a, FIG. 5 and FIG. 6. In FIG. 6 there is shown an exemplary illustration of a list of parameters that may be used by an event consumer like the event consumer 106 for subscribing with the agent 110 for a certain type of event notifications, according to the preferred embodiment of the invention. The at least one parameter 134 of message 132 preferably includes at least one of the parameters 134₁ to 134₃ as shown in FIG. 6. In FIG. 4.a, upon receipt of the subscription request message 132 from the event customer 106, the agent 110 first updates the event consumers list 210, action 136, by including the parameters 134ᵢ received in message 132 into a record of the list 210 corresponding to the event consumer EC1 106. A record of table 210 shown in FIG. 5 may be updated to comprise information related to the type of event notifications the event consumer 106 is interested in receiving, the information comprising at least one of the parameters 134₁ to 134₃. Once the event consumer table 210 is updated, assuming that the event consumer 106 has subscribed for information similar to the one generated by event producer 104, the processor 213 of the agent 110 detects a match between the type of event notifications output by event producer 104 and the type of event notifications the event consumer 106 has subscribed for, action 138. For example, such a match may be detected when the notification category parameter 134₃ recorded in table 210 for the event consumer 106 is the same with the notification category parameter 202 recorded in the event producer table 200 for the event producer 104. Following the detection of the interest of event consumer EC₁ 106 in event notifications generated by event producer 104, the agent 110 may optionally send a Suspend message 139 to instruct the event producer 104 to stop sending events, so that no event is lost during the drop of the old connection and the set-up of the new one. In such an instance, the event producer 104 suspends its transmission of events at step 141. The agent 110 further disconnects the egress port 105 of event producer 104 from the ingress port 115 of the dummy consumer 114, action 140, and because the only actual event consumer interested in the event notifications of event producer 104 is now the event consumer 106, the agent establishes a new connection between the egress port 105 of the event producer 104 and the ingress port of the event consumer 106, action 142. Optionally, the agent 110 sends a Resume message 143 to instruct event producer 104 to resume sending event notifications, action 143. As a consequence, event notifications produced by the event producer 104 that are compliant with the type of event notifications the event consumer 106 is interested in receiving, are sent from the egress port 105 of event producer 104 to the egress port 107 of event consumer 106, action 144.

At another later point in time, yet another event consumer of the management system 100, such as for example event consumer 108 may manifest an interest in receiving a similar type of event notifications. For that purpose, the event consumer 108 proceeds in a similar manner as the one described hereinabove, and sends a subscription request 146 to the agent 110, the subscription request message 146 comprising at least one type parameter 134 indicative of which event notifications the event consumer 108 is interested in receiving. In the present case, the type parameter of message 146 is assumed to be the same as the type parameter 134 of the previous message 132 and indicates an interest of event consumer 108 for the same event notifications as event consumer 106 is interested in. Upon receipt of the subscription request message 146 from the event consumer 108, the agent 110 first updates the event consumers lists 210, action 148, by including the parameters 134ᵢ of message 146 in a record of the list 210 directed to the event consumer EC2 108, as shown in FIG. 5. For example, the record of table 210 may be updated as to comprise information related to the type of event notifications the event consumer 108 is interested in receiving, this information comprising the at least one of the parameters 134₁ to 134₃. Once the event consumer table 210 is updated, the agent 110 detects a match between the type of event notifications output by event producer EP1 104 and the type of event notifications the event consumers EC1 106 and EC2 108 have subscribed for, action 150. At this point, the agent 110 has knowledge that two (2) event consumers (event customer 106 and event consumer 108) are both interested in event notifications generated by the event producer 104. Therefore, in action 152, the agent 110 detects the optimal duplication node for duplicating the event notifications information generated by the event producer 104 in view of its transmission to both event consumers 106 and 108. Reference is now made to FIG. 4.b, which is the second part of the exemplary nodal operation and signal flow diagram of FIG. 4.a. Thereafter, the agent 110 may optionally send a Suspend message 153 to instruct the event producer 104 to stop sending events, so that no event is lost during the drop of the old connection and the set-up of the new one. In action 154, the agent 110 terminates the existing connection between the egress port 105 of the event producer EP1 104 and the ingress port 107 of the event customer EC1 106, and in action 156 connects the egress port 105 of the event producer 104 to the ingress port 111 of the intermediate node 112 detected as being the optimal duplication node in action 152. The agent 110 further connects the egress port 113 of the node 112 with the ingress port 107 of the event customer 106, action 158, and also connects the egress port 113 of the node 112 with the ingress port 109 of the event customer 108, action 160. Optionally, the agent 110 may send a Resume message 161 to instruct the event producer 104 to resume sending event notifications. As a consequence, subsequent event notifications produced by the event producer EP1 104 are sent from the event producer 104 to the intermediate node 112 where they are split and further sent to both event consumers 106 and 108, as shown in action 162.

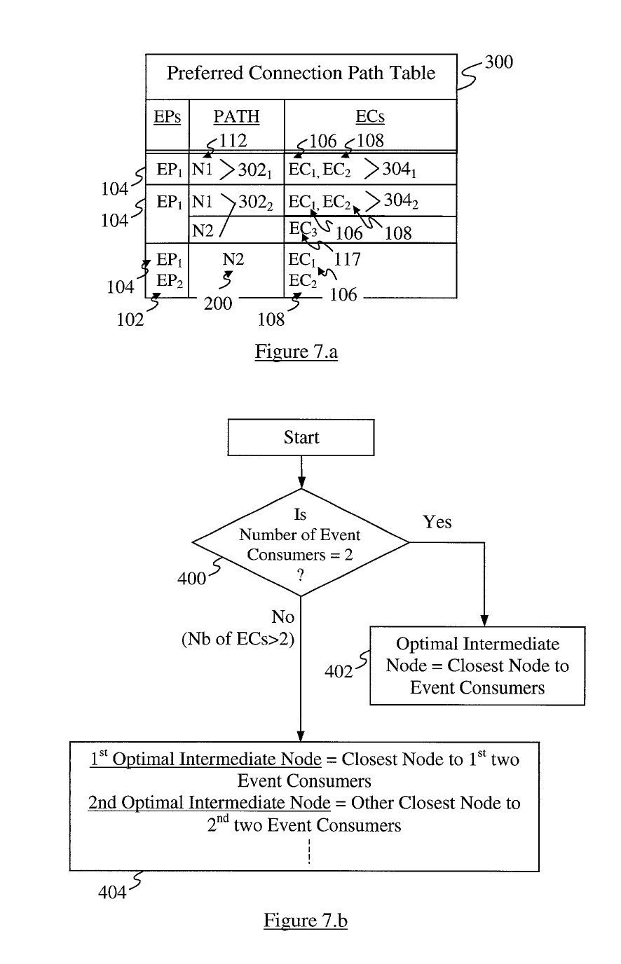

The method described in FIG. 4 may further continue and provide support for the transmission of event notifications generated by event producers to other event consumers (not shown) that subscribe with agent 110, in a manner similar to the one described hereinbefore. At each such instance, the agent 110 may detect in actions similar to action 152, the optimal connection path between one or more event producer(s) and the one or more event consumers interested in that or those event producer(s)' event notifications, and then establish a connection according to the preferred connection path. According to the preferred embodiment of the invention, the match detection between the type of event notification produced by one or more given event producers and the type of event notification requested by one or more event producers may be preformed responsive to either i) an advertisement message like message 120 or ii) as already described, a subscription request message like message 132. For example, with reference being now made to FIG. 4.c, which is the continuation of the exemplary nodal operation and signal flow diagram of FIG. 4.b, the agent 110 may further receive an advertisement message 206 from another event producer, e.g. event producer 103 that registers with the agent 110 its type 208 of event notifications it produces. Upon receipt of message 206, the agent 110 registers in its event producers table the type of event notifications 218, action 210, and detect a match between the type of event notifications produced, on one side, by the event producers 102 and 104, and the type of event notifications requested, on the other side, by the event consumers 106 and 108, action 212. In action 214, the agent 110 detects the optimal intermediate node for relaying the event notifications to the event consumers. This may be achieved in various manners according to the preferred network implementation for a given network operator, including some that are to be described with reference to FIG. 7. In action 216, the agent 110 sends a Suspend message for instructing the event producer 104 to suspend the transmission of event notifications during the set-up of the new connection, which the event producer does in action 217. Then, in action 218 the agent 110 terminates the existing connections between the event producer 104 and the intermediate node N1 112, and between the intermediate node N1 112 and the event consumers 106 and 108. Then, in action 220, the agent 110 dynamically establishes new connections between the event producer 104 and the intermediate node N2 200, detected as being the optimal duplication node, and between the intermediate node N2 200 and the event consumers 106 and 108. Likewise, the agent 110 also establishes new connections between the event producer 102 and the intermediate node N2 200, and between the intermediate node N2 200 and the event consumers 106 and 108. The agent 110 may further optionally send a Resume message 222 to instruct event producer 104 to resume sending event notifications, and a Start message 224 to instruct event producer 102 to start sending event notifications. As a result, subsequent event notifications produced by the event producer EP1 104 are sent from the egress port 105 of the event producer 104 to the ingress port 202 of the intermediate node N2 200, where they are split, and further sent to the ingress ports 107 and 109 of respective event consumers 106 and 108, as shown in action 226, while subsequent event notifications produced by the event producer EP2 102 are sent from the egress port 103 of the event producer 102 to the ingress port 202 of the intermediate node N2 200, where they are split, and further sent to the ingress ports 107 and 109 of respective event consumers 106 and 108, as shown in action 228.

According to the preferred embodiment of the invention, the detection of the optimal connection path may be performed in various manners, depending upon the preference of the network operator, and based upon various factors.

FIG. 7.a is an exemplary relational table of preferred connection paths according to a first variant of the preferred embodiment of the present invention. Table 300 may comprise pre-determined connection paths 302ᵢ between one event producer, such as one of event producers EP1 102 and EP2 104, and a corresponding group 304ᵢ of event consumers. For example, table 300 may be stored in agent 110 and include indications of the preferred path given one or more event producers that are to be connected to one or more vent consumers. For example, these indications may comprise information stating that:

i) in the case wherein event consumers of group 304₁ (event consumers EC1 106 and EC2 108) are both interested in a certain type of event notifications from event producer 104, the optimal connection path is through the intermediate node N1 112;

ii) in the case wherein event consumers of group 3042 (event consumers 106, 108, and 117) are all interested in a certain type of event notifications from event producer EP1 102, the optimal connection path is through the intermediate node N1 112 that duplicates the event notifications before relaying them to both event consumers EC1 106 and EC2 108, and through the intermediate node N2 119 that relays the vent notifications to the event consumer EC3 117 (not shown in FIG. 4.a and FIG. 4.b);

iii) in the case wherein event consumers EP1 104 and EP2 106 are to be connected to event consumers EC1 106 and EC2 108, the preferred connection path is the duplication node N2 200.

FIG. 7.b is another exemplary illustration of yet another method for detecting an optimal connection path according to a second variant of the preferred embodiment of the present invention. In FIG. 7.b, the method for selecting the optimal connection path starts by detecting if more than two (2) event consumers are to be connected for receiving the same event notifications generated by a given event consumer, action 400. If not, then the optimal intermediate node for duplicating the event notifications is the intermediate node closest to the event consumers, action 402. If more than two (2) event consumers are to be connected for receiving the same event notifications generated by a given event consumer, then in action 404 the method selects i) a first intermediate node closest to the event consumers for duplicating the event notifications for sending them to the first two event consumers and ii) a second intermediate node as close as possible to the event consumers for duplicating the event notifications and for sending them to the next event consumers. The pattern is repeated until all event consumers are assigned paths for receiving the requested event notifications.

It is to be noted that the foregoing description in relation to FIGS. 7.a and 7.b is only provided as an example, and that other manners are also possible for dynamically selecting an optimal connection path between event producers and event consumers, based on various factors, such as for example the type of event notifications involved in the subscription, the parameters of these event notifications, the existing filters applied upon the event notifications for each event consumer, etc, as preferred by a network operator or equipment manufacturer.

Based upon the foregoing, it should now be apparent to those of ordinary skilled in the art that the present invention provides an advantageous solution, which offers dynamic set up of connections between event consumers interested in receiving event notifications from certain event producers.

The system, method, and agent described in the present invention may function according to the specification of the “3^{rd} Generation Partnership Project (3GPP)'s Technical Specification Group Services and System Aspect, Telecommunication Management, Part II: Notification Integration Reference Point: Information Service Version 1 (Release 1999)—3GPP TS 32.106-2”, herein included by reference. However, it should be realized upon reference hereto that the innovative teachings contained herein are not necessarily limited thereto and may be implemented advantageously with any applicable communications standard. It is believed that the operation and construction of the present invention will be apparent from the foregoing description. While the method, system and agent shown and described have been characterized as being preferred, it will be readily apparent that various changes and modifications could be made therein without departing from the scope of the invention as defined by the claims set forth hereinbelow. For example, the processor 213 shown in the agent 110 of FIG. 5 may be any kind of hardware or software (or a combination thereof) processing functionality. Furthermore, the tables (lists) 200 and 210 of FIG. 3 may also be implemented using any kind of memory functionality, such as for example but not limited to, a table, a chip memory, a database, a list, etc.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. In a management system, a method for dynamically connecting an event consumer to at least an event producer, the method comprising the steps of:
i) transmitting a first Subscription Request message from a first event consumer to an agent, the first Subscription Request message comprising an indication of a type of event notifications the first event consumer requests for receiving;
ii) upon receipt of the first Subscription Request message, detecting in the agent if an event producer generates event notifications of the type requested by the first event consumer;
iii) if an event producer generates event notifications of the type indicated by the event consumer, dynamically connecting the event producer to the first event consumer; and
iv) sending event notifications of the type indicated by the event consumer from the event producer to the first event consumer.

2. The method claimed in claim 1, wherein the step iii) of dynamically connecting the event producer to the first event consumer comprises the step of:
v) dynamically connecting an egress port of the event producer to an ingress port of the first event consumer;
whereby the egress port of the event producer is used by the event producer to send event notifications, and the ingress port of the first event consumer is used by the first event consumer to receive event notifications.

3. The method claimed in claim 1, wherein the indication of the type of event notifications that the event consumer requests for receiving comprises a notification category parameter indicative of at least one notification category the event consumer requests for receiving.

4. The method claimed in claim 1, wherein prior to the step i) of transmitting the first Subscription Request message, the method further comprises the steps of:
vi) transmitting an advertisement message from the event producer to the agent, the advertisement message comprising an event category indicative of a type of event notifications the event producer generates; and
vii) registering in the agent the event category indicative of the type of event notifications the event producer generates.

5. The method claimed in claim 4, wherein step vii) of registering in the agent the event category indicative of the type of event notifications the event producer generates, comprises the step of:
registering in an event producer table of the agent an identity of the event producer, an identity of an egress port of the event producer, and the event category indicative of the type of event notifications the event producer generates.

6. The method claimed in claim 4, further comprises following step vii) but before step i) the steps of:
viii) detecting that no event consumer registered with the agent an interest in receiving event notifications of the category the event producer generates;
ix) connecting the event producer to a dummy event consumer that discards every received event notification;
x) sending the event notifications of the category the event producer generates from the event producer to the dummy event consumer; and
xi) upon receipt in the dummy event consumer, discarding the event notifications of the category the event producer generates.

7. The method claimed in claim 6, wherein:
step ix) comprises connecting the egress port of the event producer to an ingress port of the dummy event consumer;
step x) comprises sending the event notifications of the category the event producer generates from the egress port of the event producer to the ingress port of the dummy event consumer.

8. The method claimed in claim 6, further comprises before step iii) of dynamically connecting the event producer to the first event consumer, the step of:
disconnecting the event producer from the dummy event consumer.

9. The method claimed in claim 1, further comprising the steps of:
v) transmitting a second Subscription Request message from a second event consumer to the agent, the second Subscription Request message comprising an indication of a type of event notifications the second event consumer requests for receiving;
vi) upon receipt of the second Subscription Request message, detecting in the agent that the type of event notifications the second event consumer is interested in receiving is the same as the type of event notifications generated by the event producer and currently received by the first event consumer;
vii) detecting an optimal intermediate duplication node for duplicating the event notifications generated by the event producer in view of their transmission to both the first and the second event consumer;
viii) disconnecting the event producer from the first event consumer;
ix) dynamically connecting the event producer to detected optimal intermediate duplication node;
x) dynamically connecting the detected optimal intermediate duplication node to the first event consumer;
xi) dynamically connecting the detected optimal intermediate duplication node to the second event consumer; and
viii) sending the event notifications of the given type from the detected optimal intermediate duplication node to both the first and the second event producers.

10. The method claimed in claim 9, wherein:
the step viii) comprises disconnecting an egress port of the event producer from an ingress port of the first event consumer;
the step ix) comprises dynamically connecting the egress port of the event producer to an ingress port of the detected optimal intermediate duplication node;
the step x) comprises dynamically connecting an egress port of the detected optimal intermediate duplication node to the ingress port of the first event consumer;
the step xi) comprises dynamically connecting the egress port of the detected optimal intermediate duplication node to an ingress port of the second event consumer; and
the step viii) comprises sending the event notifications of the given type a) from the egress port of the detected optimal intermediate duplication node to the ingress port of the first event producers, and b) from the egress port of the detected optimal intermediate duplication node to the ingress port of the second event producers.

11. A management system comprising:
a first event consumer transmitting a first Subscription Request message, the first Subscription Request message comprising an indication of a type of event notifications the first event consumer requests for receiving;
one or more event producers;
an agent receiving the first Subscription request from the first event consumer and, upon receipt of the first Subscription Request message, detects if an event producer of the one or more event producers generates event notifications of the type requested by the first event consumer;
wherein if an event producer generates event notifications of the type indicated by the event consumer, the agent dynamically connects the event producer to the first event consumer so that the event notifications of the type indicated by the event consumer are sent from the event producer to the first event consumer.

12. The management system claimed in claim 11, wherein:
the event producer comprises an egress port for sending event notifications;
the first event consumer comprises an ingress port for receiving event notifications; and
the agent dynamically connects the egress port of the event producer to the ingress port of the first event consumer.

13. The management system claimed in claim 11, wherein the indication of the type of event notifications that the event consumer requests for receiving comprises a notification category parameter indicative of at least one notification category the event consumer requests for receiving.

14. The management system claimed in claim 11, wherein before the transmission of the first Subscription Request message by the first event consumer, the event producer transmits an advertisement message to the agent, the advertisement message comprising an event category indicative of the type of event notifications the event producer generates, and the agent registers the event category indicative of the type of event notifications the event producer generates.

15. The management system claimed in claim 14, wherein the agent comprises an event producer table for registering an identity of the event producer, an identity of an egress port of the event producer, and the event category indicative of the type of event notifications the event producer generates.

16. The management system claimed in claim 14, further comprising:
a dummy event consumer that discards every received event notification;
wherein when the agent detects that no event consumer registered with the agent requested to receive event notifications of the category the event producer generates, the agent connects the event producer to the dummy event consumer and sends the event notifications of the category the event producer generates from the event producer to the dummy event consumer, which discards the event notifications upon receipt.

17. The management system claimed in claim 16, wherein:
the agent connects the egress port of the event producer to an ingress port of the dummy event consumer, and the event notifications of the category the event producer generates are sent from the egress port of the event producer to the ingress port of the dummy event consumer.

18. The management system claimed in claim 16, wherein before dynamically connecting the event producer to the first event consumer, the agent first disconnects the event producer from the dummy event consumer.

19. The management system claimed in claim 11, wherein:
a second event consumer transmits a second Subscription Request message to the agent, the second Subscription Request message comprising an indication of a type of event notifications the second event consumer requests for receiving;
upon receipt of the second Subscription Request message, the agent detects that the type of event notifications the second event consumer is interested in receiving is the same as the type of event notifications generated by the event producer and currently received by the first event consumer;
the agent detects an optimal intermediate duplication node for duplicating the event notifications generated by the event producer in view of their transmission to both the first and the second event consumer;
the agent disconnects the event producer from the first event consumer;
the agent dynamically connects the event producer to the detected optimal intermediate duplication node;
the agent dynamically connects the detected optimal intermediate duplication node to the first event consumer;
the agent dynamically connects the detected optimal intermediate duplication node to the second event consumer; and
the event producer sends the event notifications to the detected optimal intermediate duplication nodes, which relays the event notifications to both the first and the second event producers.

20. The management system claimed in claim 19, wherein:
when the agent disconnects the event producer from the first event consumer, the agent disconnects an egress port of the event producer from an ingress port of the first event consumer;
when the agent dynamically connects the event producer to the detected optimal intermediate duplication node, the agent dynamically connects the egress port of the event producer to an ingress port of the detected optimal intermediate duplication node;
when the agent dynamically connects the detected optimal intermediate duplication node to the first event consumer, the agent dynamically connects an egress port of the detected optimal intermediate duplication node to the ingress port of the first event consumer;
when the agent dynamically connects the detected optimal intermediate duplication node to the second event consumer, the agent dynamically connects the egress port of the detected optimal intermediate duplication node to an ingress port of the second event consumer; and
when the event notifications of the given type are relayed to both the first and the second event producers, the event notifications of the given type are sent from the egress port of the detected optimal intermediate duplication node to the ingress port of the first event producers, and from the egress port of the detected optimal intermediate duplication node to the ingress port of the second event producer.

21. An agent of a management system, comprising:
an event producer table comprising information related to event producers managed by the agent, the information related to event producers managed by the agent comprising a type of event notifications generated by the event producers;
an event consumer table comprising information related to event consumers managed by the agent, the information related to event consumers managed by the agent comprising a type of event notifications requested by the event consumers; and
a processor for detecting a match between the type of event notifications generated by a first event producer from the event consumers managed by the agent, and the type of event notifications requested by a first event consumer from the event consumers managed by the agent;
wherein when the match is detected, the processor dynamically connects the first event producer to the first event consumer;
whereby the event notifications of the matched type are transmitted from the first event producer to the first event consumer.

22. The agent claimed in the management system claimed in claim 21, wherein:
the event producer table comprises, for each event producer registered with the agent, an identity of the event producer, an address of an egress port of the event producer, and an event category identifying the type of event notifications produced by the event producer;
the event consumer table comprises, for each event consumer registered with the agent, an identity of the event consumer, an address of an ingress port of the event consumer, and an event category identifying the type of event notifications requested by the event consumer; and
when the processor detects a match between an event category identifying the type of event notifications produced by the first event producer and an event category identifying the type of event notifications requested by the first event consumer, the processor dynamically connects the egress port of the first event producer to the ingress port of the first event consumer.

23. The agent claimed in claim 21, wherein the match is detected responsive to a receipt by the agent of an advertisement message sent by the first event producer, the advertisement message comprising a first event category identifying the type of event notifications produced by the first event producer.

24. The agent claimed in claim 21, wherein the match is detected responsive to a receipt by the agent of subscription request message sent by the first event consumer, the subscription request message comprising a first event category identifying the type of event notifications requested by the first event consumer.

25. The agent claimed in claim 22, wherein the agent's event producer table is provided with the information related to event producers managed by the agent from advertisement messages received from the event producers managed by the agent, each advertisement message comprising the type of event notifications generated by that event producer.

26. The agent claimed in claim 23, wherein:
the agent receives a second Subscription Request message from a second event consumer, the second Subscription Request message comprising an indication of a type of event notifications the second event consumer requests for receiving;
upon receipt of the second Subscription Request message, the agent's processor detects that the type of event notifications the second event consumer requests for receiving is the same as the type of event notifications generated by the event producer and currently received by the first event consumer;
the agent detects an optimal intermediate duplication node for duplicating the event notifications generated by the event producer in view of their transmission to both the first and the second event consumer;
the agent disconnects the event producer from the first event consumer;
the agent dynamically connects the event producer to the detected optimal intermediate duplication node;
the agent dynamically connects the detected optimal intermediate duplication node to the first event consumer;
the agent dynamically connects the detected optimal intermediate duplication node to the second event consumer; and
the event producer sends the event notifications to the detected optimal intermediate duplication nodes, which relays the event notifications to both the first and the second event producers.

27. The agent claimed in claim 26, wherein:
when the agent disconnects the event producer from the first event consumer, the agent disconnects an egress port of the event producer from an ingress port of the first event consumer;
when the agent dynamically connects the event producer to the detected optimal intermediate duplication node, the agent dynamically connects an egress port of the event producer to an ingress port of the detected optimal intermediate duplication node;
when the agent dynamically connects the detected optimal intermediate duplication node to the first event consumer, the agent dynamically connects an egress port of the detected optimal intermediate duplication node to the ingress port of the first event consumer;
when the agent dynamically connects the detected optimal intermediate duplication node to the second event consumer, the agent dynamically connects the egress port of the detected optimal intermediate duplication node to an ingress port of the second event consumer; and
when the event notifications of the given type are relayed to both the first and the second event producers, the event notifications of the given type are sent from the egress port of the detected optimal intermediate duplication node to the ingress port of the first event producers, and from the egress port of the detected optimal intermediate duplication node to the ingress port of the second event producer.

28. The agent claimed in claim 21, wherein when the match is detected, the agent dynamically connects the first event producer to the first event consumer via at least one intermediate node.

29. The agent claimed in claim 21, wherein the processor detects a match between the type of event notifications generated by the first event producer and a type of event notifications requested by i) the first event consumer and ii) a second event consumer from the event consumers managed by the agent and, when the match is detected, the agent dynamically connects the first event producer to the first and second event consumers via at least one intermediate node.

30. The agent claimed in claim 29, wherein the at least one intermediate node comprises an optimal duplication node for duplicating event notifications received from the first event producer for relaying the event notifications to the first and second event consumers.

31. The agent claimed in claim 21, wherein the processor detects a match between a type of event notifications generated on one side by the first event producer and a second event producer from the event consumers managed by the agent, and on the other side, a type of event notifications requested by the first event consumer and a second event consumer from the event consumers managed by the agent, and, when the match is detected, the agent dynamically connects the first event producer and the second event producer to the first event consumer and the second event consumer via at least one intermediate node.

32. The agent claimed in claim 31, wherein the at least one intermediate node comprises an optimal duplication node for duplicating i) event notifications received from the first event producer for relaying the event notifications to the first and second event consumer, and ii) event notifications received from the second event producer for relaying the event notifications to the first and second event consumers.
